(19) United States
(12) Patent Application Publication
(10) Pub. No.: US 2007/0101185 A1
(43) Pub. Date: May 3, 2007

(54) MULTI-ROOM NETWORK GUIDE WITH SCHEDULING DEVICE INDICATORS

(75) Inventor: Barbara Ostrowka, Lawrenceville, GA (US)

Correspondence Address: SCIENTIFIC-ATLANTA, INC.;INTELLECTUAL PROPERTY DEPARTMENT, 5030 SUGARLOAF PARKWAY, LAWRENCEVILLE, GA, 30044, US

(73) Assignee: SCIENTIFIC-ATLANTA, INC., Lawrenceville, GA (US)

(21) Appl. No.: 11/163,755

(22) Filed: Oct. 28, 2005

(51) Int. Cl. G06F 11/00

(52) U.S. Cl. 714/6

(57) ABSTRACT

Multi-room network guide with scheduling device indicators. The networked multi-room system is made up of at least one primary device and one or more remote devices. The remote devices are able to view the network guide saved on the primary device and schedule programs to be recorded. When viewing the network guide or the recorded programs list, from any of the devices, the presentation scheduled to be recorded, or presentations saved to the hard drive, will have an indicator corresponding to the device that requested the recording. The indicator could be color, icons, or text.

### CROSS-REFERENCE TO RELATED PATENT APPLICATIONS

The present application is a continuation-in-part (CIP) of U.S. patent applications “Parental Control for a Multi-Room Networked System” and “Interactive Network Guide with Parental Monitoring” having Ser. Nos. 11/069,439 and 11/069,440, respectively, which were both filed on Mar. 1, 2005, the disclosures and teachings of which are hereby incorporated by reference.

### FIELD OF THE INVENTION

This invention relates in general to broadband communications systems, and more particularly, to the field of network multimedia systems having a multi-room interactive network guide.

### DESCRIPTION OF THE RELATED ART

Broadband communications systems, such as satellite and cable television systems, are now capable of providing many services in addition to analog broadcast video. In implementing enhanced programming, the set-top terminal (STT), otherwise known as the set-top box, has become an important computing device for accessing various video services. In addition to supporting traditional analog broadcast video functionality, many STTs now also provide other functionality, such as, for example, an interactive program guide (IPG), picture-in-picture (PIP) viewing, video-on-demand (VOD), subscription video-on-demand (SVOD) and functionality traditionally associated with a conventional computer, such as e-mail. Recently new functionality has been added to conventional STTs—namely the ability to record an incoming video stream in digitized form onto a mass storage device, such as a hard disk drive, and play back that recorded video as desired by the user. This functionality has become known as a “digital video recorder” (DVR) or personal video recorder (PVR) and is viewed as a superior alternative to conventional video tape recorders for capture and subsequent playback of programming content.

A STT is typically connected to a television set and located at the home of the cable or satellite system subscriber. Since the STT is located at a subscriber's premises, it typically may be used by two or more users (e.g., household members). Also, television has become so prevalent in the United States that the typical household may have two or more television sets, each television set requiring its own STT if a subscriber wishes to have access to enhanced functionality.

The networked multi-room system (NMS) allows a plurality of remote devices in the premises to be locally networked (i.e., home-networked). One or more of the remote devices typically acts as a server or primary device (i.e., the primary set-top terminal) in the NMS. The primary device receives and forwards upon request broadband multimedia presentations (e.g., analog or digital television channels (i.e., audio/video signals), IP signals, video-on-demand (VOD) signals, administrative signals, etc.) throughout the local network to the plurality of remote devices (i.e., client devices, remote set-top terminals). Furthermore, the remote devices are each capable of requesting and seamlessly receiving from the primary device resident presentations, such as a stored or recorded presentation, the interactive program guide (IPG), or the network guide, for example. Additionally, the remote devices may independently receive presentations from and send upstream signals to the communications network. Accordingly, the remote devices may be simplified, less-costly versions of the primary device but are capable of utilizing, via the NMS, some or all of the advanced hardware and software features, such as memory, a mass storage device, software applications, or infrastructure for transmitting signals back to the headend, that are available in the primary device.

Multiple users operating discrete STTs within a networked premises have access to the programming and content received by and/or stored in other STTs. Therefore, there exists a need for the ability to control and/or monitor the STTs within the networked premises, such as a client STT, or remote device, being able to view from either the primary or any remote device the schedule of content that is being recorded, which content is scheduled to be recorded, or which content has been recorded on the primary device.

### BRIEF DESCRIPTION OF THE DRAWINGS

The invention can be better understood with reference to the following drawings. The components in the drawings are not necessarily drawn to scale, emphasis instead being placed upon clearly illustrating the principles of the invention. In the drawings, like reference numerals designate corresponding parts throughout the several views.

FIG. 1 is a simplified block diagram depicting a non-limiting example of a conventional broadband communications system with a networked multi-room system (NMS).

FIG. 2 illustrates an interactive program guide (IPG), which is suitable for use in the NMS of FIG. 1.

FIG. 3 illustrates a non-limiting example of one embodiment of an interactive program guide (IPG), which depicts programs to be recorded.

FIG. 4 illustrates further functionality listings of an IPG, such as a personal video recording (PVR) recorded programs list and the network guide (NG).

FIG. 5 depicts a non-limiting example of a recorded programs list screen that may be presented to a remote device via the NMS of FIG. 1.

### DETAILED DESCRIPTION

The embodiments of the invention can be understood in the context of a broadband communications system and a local network system. Note, however, that the invention may be embodied in many different forms and should not be construed as limited to the embodiments set forth herein. For example, transmitted broadband signals may include at least one of video/audio, telephony, data, or Internet Protocol (IP) signals, to name but a few. Furthermore, remote devices included in the local network system receiving the transmitted broadband signals may include a set-top terminal (STT), a television, a computer, a personal digital assistant (PDA), or other display device. Moreover, in accordance with the present invention, a multi-room interactive network guide can have various features, functions, and presentations when displayed. All examples given herein, therefore, are intended to be non-limiting and are provided in order to help clarify the description of the invention.

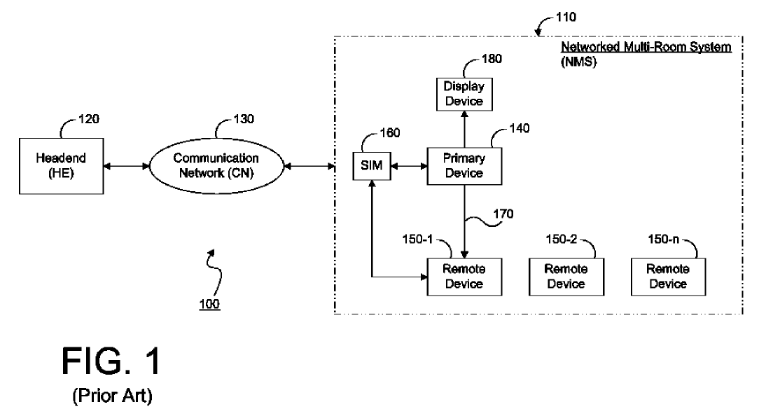

FIG. 1 is a simplified block diagram depicting a non-limiting example of a conventional broadband communications system 100. In this example, the communications system 100 includes a local networked multi-room system (NMS) 110 that is coupled to a headend (HE) 120 via a communications network (CN) 130. The CN 130 may be any network that is suitable for carrying, preferably downstream and upstream, broadband multimedia signals, such as audio/video signals, IP signals, telephony signals, or data signals. The CN 130 may be, for example, a hybrid fiber/coax (HFC) network, a fiber-to-the-home (FTTH) network, a satellite network, or a fixed wireless network (e.g., MMDS), among others.

The HE 120 may include one or more server devices for providing broadband signals, such as video, audio, and/or data signals, to a primary device 140 via the CN 130. The HE 120 and the primary device 140 cooperate to provide a user with a variety of services. The services may include, for example, analog or digital broadcast television services and channels, video-on-demand (VOD) services, and/or pay-per-view (PPV) services, among others. Each broadcast television channel typically provides a sequence of television presentations corresponding to a television station (e.g., ABC, NBC, CBS, or FNN) and is typically identified by a channel number (e.g., channel 2, channel 3, channel 4) that is available to a user at all times. Additionally, PPV services are typically transmitted to the primary device 140 at all times, but can only be viewed on the primary device 140 as provisioned. On the other hand, the primary device 140 typically requests a VOD service and, subsequently, the HE 120 transmits the presentation downstream to the primary device 140.

The NMS can include a router, but as shown in FIG. 1, the NMS 110 includes a splitter/isolator module (SIM) 160 that receives downstream broadband signals from the HE 120 and subsequently provides the downstream signals to the primary device 140 or to both the primary device 140 and any one or all of the remote devices 150-1 to 150-n depending on the implementation. Upon command from at least one of the remote devices 150-1 to 150-n, the primary device 140 may also forward selected real-time downstream signals and/or stored content signals to the requesting remote device 150-1, for example, via the SIM 160. The remote device 150-1 communicates with the primary device 140 by sending reverse control/command signals via coaxial cable requesting stored presentations, real-time signals, or the network guide. Other wired mediums, such as telephone lines or data cables, may be used so long as the transport format accommodates the desired transmission medium. The remote devices 150-1 to 150-n have access to all of the primary device 140's hardware and software functionality, along with receiving downstream signals directly from the headend via the SIM 160. Therefore, the remote devices 150-1 to 150-n may have limited resources, such as not including a storage device in order to record and store a presentation, thereby decreasing the overall costs to the service provider and the subscriber while offering advanced services to all of the remote devices 150-1 to 150-n that are networked to the primary device 140.

Furthermore, the primary device 140 may also directly provide signals, such as analog and digital channels, stored presentations, or the network guide, to a coupled display device 180, which may be, for example, a television, computer, or PDA (personal digital assistant), among others. The primary device 140 may transmit signals to and receive control signals from the display device 180 via wireless devices (e.g., RF or IR devices) or a wired medium (e.g., coaxial cable, power lines, or telephone lines). The primary device 140 may be incorporated in the display device 180.

The primary device 140, in accordance with one embodiment of the present invention, includes a processor, a tuner system, a storage device, a modulator, and a remote device communications receiver. Each of the remote devices, such as the remote device 150-1, may be identical to the primary device 140 and just share the storage device contents of the primary device 140. Alternatively, the remote device 150-1 may be a simplified or conventional version of the primary device 140. A processor and a tuner system, which may be a simplified processor and only one tuner, may be included to extract channels from the received downstream broadband signals. Additionally, decryptors and decoders may be included to decode encoded signals for proper processing and display. Preferably, the remote device 150-1 includes a user input receiver, such as an IR receiver or an RF receiver, that receives signals from a remote control, such as an IR remote control or an RF remote control. The remote control is not required and any user input device could be incorporated in the remote device 150-1.

In the event that the remote device 150-1, upon user input, requests a presentation, a reverse command signal is transmitted from the remote device 150-1 to the primary device 140 via the SIM 160. The remote device command receiver receives and demodulates the command signal according to its transmission method, such as frequency-shift keying (FSK) or on-off keying (OOK) transmission. The processor subsequently receives the demodulated command signals indicative of the requested action (e.g., requesting a presentation) and in accordance therewith instructs the tuner to tune to, for example, a channel carrying a real-time downstream signal, or the processor may retrieve a stored presentation from the storage device. The presentation's content signals are then provided to the modulator, which modulates the selected presentation prior to forwarding to the SIM 160. A preferred embodiment of the present invention uses a quadrature amplitude modulation (QAM) modulator, which may be used for effectively transmitting signals over coaxial cable in a cable television environment.

The presentations stored in the storage device of the primary device 140 include program identifiers (PIDs), which may be indexed and stored as a table in the primary device's memory. The remote devices 150-1 to 150-n may watch a single stored presentation by remapping the PID value of the stored program to a different PID value prior to modulation. In this manner, the single stored program basically remains in the storage device, while the transmitted presentation is a copy of the stored presentation having a remapped PID value.

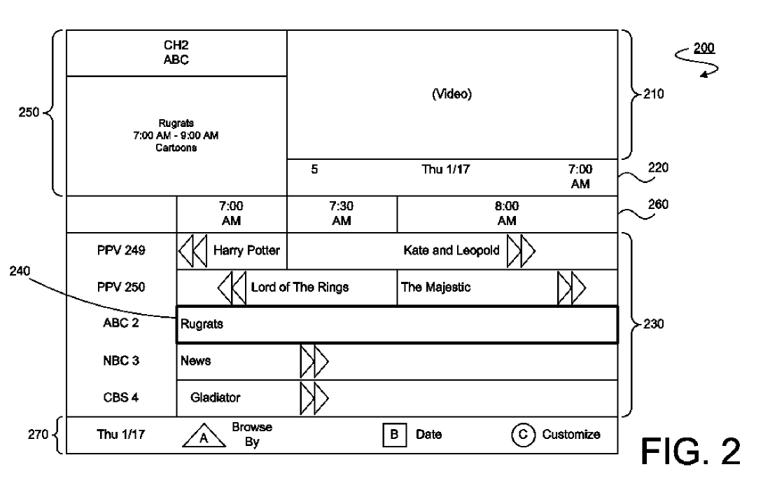

FIG. 2 illustrates a non-limiting example of an interactive program guide (IPG) screen 200 that is suitable for use in the NMS 110 of FIG. 1. The IPG screen 200 may be presented in response to user input that may be provided via the activation of a guide key on the remote control. When a remote device 150-1, for example, requests the network guide, the processor accesses the network guide 200, which is stored in memory of the primary device 140, and subsequently forwards the content signals indicative of the network guide 200 to the modulator for modulation and transmission to the requesting remote device 150-1.

In the top right of the IPG screen 200, video corresponding to the channel to which the primary device 140 is currently tuned may be displayed in the video area 210. Immediately below the video area 210 is an information banner 220 for displaying the channel number corresponding to the channel to which the primary device 140 is currently tuned, the current day and date, and the current time.

Arrow buttons on the remote control can be used to scroll through a main presentation listing 230 and to highlight a desired presentation 240, in this case entitled Rugrats. The top left portion of the network guide 200 is a detailed focus area 250 that includes detailed information for the currently highlighted presentation 240. The detailed focus area 250 may include channel number, channel description, presentation name, duration of the presentation, and/or any other episode information or rating. As a user scrolls in time across a calendar day boundary 260, the day and date indications displayed in various areas are updated. The bottom area 270 of the network guide 200 also indicates the current day for which presentation listing data is being displayed as well as information about the current functions of the optional “A,” “B,” and “C” keys that may be on the remote controls and are used in conjunction with the IPG.

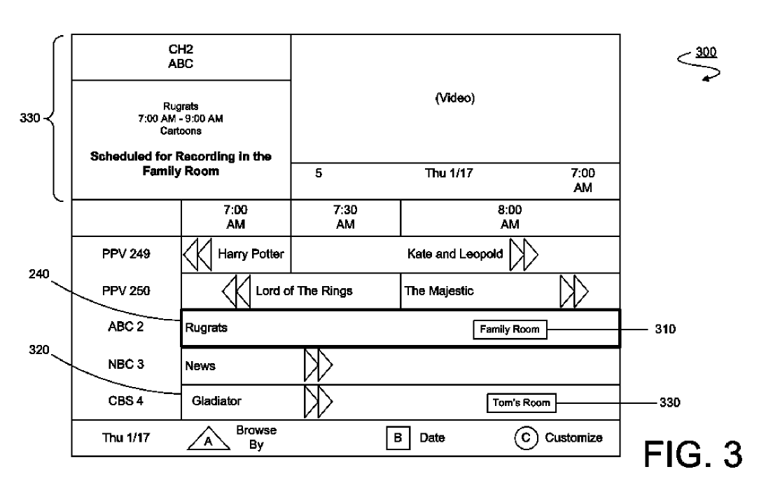

FIG. 3 illustrates a network guide or IPG screen 300 showing scheduled recordings. A user of one of the remote devices 150-1 to 150-n can access the IPG screen 300 and choose a program to record. For example, through the remote control, the user highlights the presentation 240 entitled Rugrats and then may choose whether to record only this episode or all episodes, from a separate screen. The user makes their selection and the highlighted presentation is now set to record. There are numerous methods for indicating the device which the request to schedule the presentation for recording originated from. The indicators for identifying which device scheduled the recording may be, for example, color, icons, text, or any other suitable means for distinguishing a primary or remote device that is recording a presentation, scheduled a presentation for recording, or stored a presentation, from another. All scheduled presentations could each be displayed in a colored field where particular colors are associated with corresponding primary or remote devices. Alternatively, when the user highlights a field or presses a button on the remote control, text describing the device that scheduled a recording could be displayed as shown in the detailed focus area 330. In another embodiment, an icon associated with a particular device or a text overlay could identify the requesting device and could also be displayed within the field of the presentation or only appear when a user highlights the field of the presentation. For example, the presentation 240 entitled Rugrats has a text overlay 310 stating “Family Room” and the presentation 320 entitled Gladiator has a text overlay 330 stating “Tom's Room.”

After scheduling a recording from either the primary device 140 or one of the remote devices 150-1 to 150-n, the updated network guide 300 is saved with the new information. For example, the remote device 150-1 transmits the new information via the SIM 160 to the primary device 140 in order to update the network guide 300, which is stored in the primary device 140. The primary device 140 then broadcasts, either upon request or in a carousel manner, the updated network guide 300 to the remote devices 150-1 to 150-n.

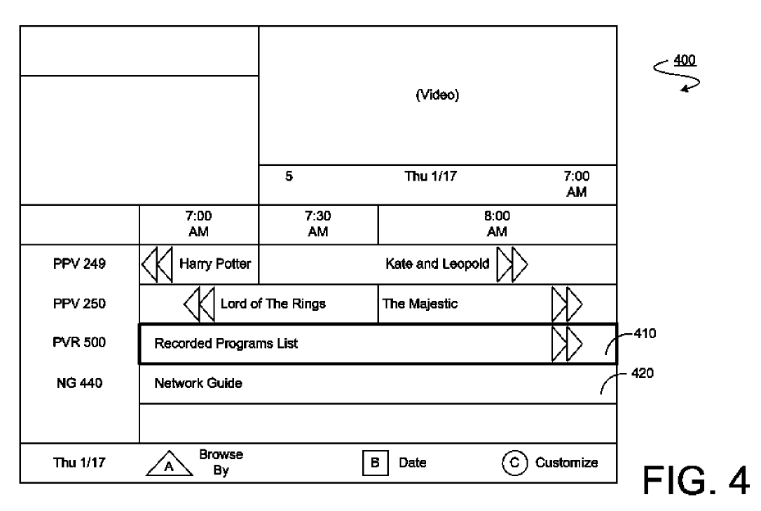

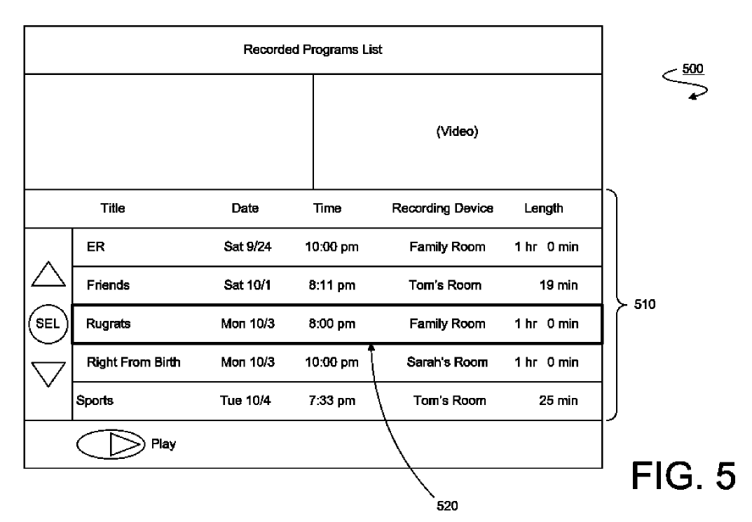

FIG. 4 illustrates the further functionality listings of an IPG screen 400, having a personal video recording (PVR) listing 410 and a network guide listing (NG) 420. Highlighting and selecting the PVR listing 410 accesses a recorded programs list screen 500 as shown in FIG. 5. Alternatively, the user can select the channel number using number keypads on the remote control to navigate to either the recorded programs list screen 500 or the network guide 420.

FIG. 5 depicts a non-limiting example of the interactive recorded programs list screen 500 showing a portion of a recorded programs list 510 that may be presented to the remote devices 150-1 to 150-n via the NMS 110 of FIG. 1. The recorded programs list screen 500 displays one or more recorded programs 510 and, if desired, the title, the recording date and time, the device that scheduled the recording, and the length of the program. However, instead of displaying the device that scheduled the recording, one or more recorded programs 510 could be colored or have colored text which corresponds with the device that requested or scheduled the recordings. An icon could also be used in place of displaying the name of the device that requested the recording.

A recorded presentation in the highlighted program line 520 can typically be selected for viewing by pressing a select button or a play button on a remote control. When a remote device 150-1, for example, requests a list of the recorded programs, the processor accesses the recorded programs list 510, which is stored in memory of the primary device 140, and subsequently forwards the content signals indicative of the recorded programs list 510 to the modulator for modulation and transmission to the requesting remote device.

For example, still referring to FIG. 5, a recorded presentation 520 entitled Rugrats was recorded on Monday, October 3 and is one hour in length. The recording was scheduled to be recorded by a user in the Family Room. After the user selects the recorded presentation 520, the remote device 150-1, for example, sends a reverse command signal that is indicative of the selected recorded presentation (i.e., Rugrats) to the remote command receiver via the SIM 160. The processor extracts recorded presentation 520 from the storage device using an identifier as described above. The presentation 520 is subsequently modulated and transmitted to the SIM 160 for delivery to the remote device 150-1. The requesting remote device 150-1 tunes to the modulator frequency and waits for the response (i.e., the presentation entitled Rugrats).

There are times when multiple devices will attempt to schedule recordings at the same time. It is possible to set up a priority scheme, where a user determines which device will always receive top priority. The user attempting to make an overlapping recording would be notified at the time of scheduling and could determine whether to proceed and interrupt the previously scheduled recording. These situations can arise regardless of the number of tuners in the primary device 140.

It should be emphasized that the above-described embodiments of the invention are merely possible examples, among others, of the implementations, setting forth a clear understanding of the principles of the invention. Many variations and modifications may be made to the above-described embodiments of the invention without departing substantially from the principles of the invention. All such modifications and variations are intended to be included herein within the scope of the disclosure and invention and protected by the following claims. In addition, the scope of the invention includes embodying the functionality of the embodiments of the invention in logic embodied in hardware and/or software-configured mediums.

What is claimed is:

1. A networked multimedia system (NMS) comprising:
a primary device for receiving and tuning presentations;
a network guide on said primary device; and
at least one remote device in communication with said primary device for receiving said network guide, and for requesting a presentation to be recorded to said primary device, and said network guide providing an indication that either said primary or remote devices requested said presentation for recording.

2. The NMS of claim 1, wherein said indication is a color.

3. The NMS of claim 1, wherein said indication is text.

4. The NMS of claim 1, wherein said indication is an icon.

5. The NMS of claim 1, wherein said indication appears in response to a user highlighting a field in said network guide.

6. The NMS of claim 1, wherein said indicator is displayed in association with said presentation on a recorded programs list.

7. A network guide for use in a networked multi-room system (NMS) comprising:
a program menu arranged by channel and time on a primary device in the NMS; and
a presentation in said program menu having an indication identifying whether said primary device or a remote device requested said presentation for recording.

8. The network guide of claim 7, wherein said indicator identifies said primary device as requesting the recording of said presentation.

9. The network guide of claim 7, wherein said indicator identifies one of said remote devices as requesting the recording of said presentation.

10. The network guide of claim 7, wherein said indication is one of a color, text, and an icon.

11. The network guide of claim 7, wherein said indication appears in response to a user highlighting a field in said network guide.

12. A networked multimedia system (NMS) comprising:
a primary device for receiving and tuning presentations;
at least one remote device in communication with said primary device; and
a recorded programs list displayed from said primary device or said remote device, wherein said recorded programs list provides an indication of which of said primary or remote devices scheduled each of said recorded programs.

13. The NSM of claim 12, wherein one said indication identifies said primary device as requesting the recording of one said presentation of said recorded programs list and another said indication identifies said remote device as requesting the recording of another said presentation of said recorded programs list.

14. The NMS of claim 12, wherein each said indication is a color.

15. The NMS of claim 12, wherein each said indication is text.

16. The NMS of claim 12, wherein each said indication of scheduling is an icon.

17. The NMS of claim 12, wherein said indication appears in response to a user highlighting a field in said recorded programs list.

18. A recorded programs list in a network guide for use in a networked multi-room system (NMS) comprising:
a first presentation in said recorded programs list with a first indication identifying a primary device of said NMS as requesting said first presentation for recording; and
a second presentation in said recorded programs list with a second indication identifying a remote device of said NMS as requesting said second presentation for recording.

19. The recorded programs list of claim 18, wherein said indication is one of a color, text, and an icon.

20. The recorded programs list of claim 18, wherein said indication appears in response to a user highlighting a field in said recorded programs list.

21. A method of indicating which device scheduled a recording on a network guide in a networked multi-room system (NMS), said method comprising the steps of:
storing said network guide on a primary device of said NMS;
receiving said network guide on one or more remote devices;
requesting a first presentation to be recorded to said primary device; and
providing an indication in said network guide of whether said primary device or one of said remote devices requested said first presentation be recorded.

22. The method of claim 21, further comprising the step of requesting a second presentation to be recorded to said primary device and providing an indication in said network guide of whether said primary device or one of said remote devices requested said second presentation be recorded.

23. The method of claim 21, wherein said indication identifies said primary device as requesting the recording of said first presentation.

24. The method of claim 21, wherein said indication identifies one of said remote devices as requesting the recording of said first presentation.

25. The method of claim 21, further comprising the step of displaying said indication as one of a color, text, and an icon.

26. The network guide of claim 21, wherein said indication appears in response to a user highlighting a field in said network guide.
